(19) United States
(12) Patent Application Publication
(10) Pub. No.: US 2023/0222611 A1
(43) Pub. Date: Jul. 13, 2023

(54) System and Method for Arranging and Rating Dispute Resolution Services Through the Use of Mobile and Other Computing Devices

(71) Applicant: David Fuller, Springville, UT (US)

(72) Inventor: David Fuller, Springville, UT (US)

(21) Appl. No.: 17/571,502

(22) Filed: Jan. 9, 2022

(51) Int. Cl. G06Q 50/18; G06Q 50/26

(52) U.S. Cl. CPC G06Q 50/182; G06Q 50/26; G06Q 20/102

(57) ABSTRACT

A method and system for fairly and affordably connecting dispute litigants with self-help services, attorneys, judges, and juries is provided to open up new possibilities for resolving legal disputes in a privatized forum.

### CROSS-REFERENCE TO RELATED APPLICATIONS

This application claims priority to Utility patent application Ser. No. 15/356,700 filed by same inventors on Nov. 21, 2016 in turn claiming priority to provisional patent application 62/260,195 also by same inventors on Nov. 15, 2015.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The Field of the invention is online alternative dispute resolution. Where disputes and conflicts exist among people, including disputes of fact and law, resolution of causes of action can be effectuated contractually in forums other than the Federal or State courts of jurisdiction. Jurisdiction is most often based on the location where the Defendant resides or the location in which the actions or activities that gave rise to the dispute occurred.

While there are existing solutions or services with an online presence such as general or jurisdictional state court websites, there is a need for a complete virtual system that brings judges, juries, parties, and attorneys access to dispute resolution in a forum with enough tools to perform settlement and litigation tasks online which are backed by a rating system so that the best services are identified and rewarded. Connecting dispute litigants with not just privatized self-help access, but also to researchers, attorneys, judges, and juries will open up new possibilities for resolving disputes with win-win possibilities online.

### BRIEF SUMMARY OF THE INVENTION

Like typical courts, state bar associations, litigation funding organizations, ADR, ODR, commercial complaint forums, or online legal form services, this invention will provide a system and method for providing dispute settlement without costly legal battles. But unlike other forums for dispute resolution, this system and method has a privatized rating system on all researchers, judges, jurors, attorneys or other service providers. The service providers are required to first prove that they are approved or appointed by state or federal governments and/or municipalities. They are also subject to a separate application and fee structure based on the invented system ratings and/or other criteria recorded by the invented system.

Even though the government jurisdictional courts have exclusive jurisdiction on finalizing legal disputes, litigants have a right to contract with one another to agree to solve their disputes in non-governmental forums. In this system and method, once a case is decided, the parties can rate judges and jurors prior to any settlement or judgment disbursement. Judges, jurors, attorneys, and parties can all apply to qualify to participate in a private web based forum where they can activate an account to sign up for resolving their particular dispute. In some embodiments, researchers, experts, and/or other witnesses may also participate.

### BRIEF DESCRIPTION OF THE SEVERAL VIEWS OF THE DRAWINGS

FIG. 1 illustrates an organizational workflow chart for connecting “Parties” with “Providers.” The judges, juries, researchers, attorneys, or other useful practitioners who are prequalified and rated by present and previous litigants are the online entities who sign up to become Providers. Entities who are directly involved in any particular dispute are the Parties. The researchers, judges, juries, and attorneys are the Providers. Experts and other witnesses normally participate only through document evidence provided by the Parties or Participants in the preferred embodiment, but in other embodiments witnesses may be sworn in at trial. Providers are rated by Parties and rated by each other.

FIG. 2 illustrates a typical logical device schematic for a mobile or handheld computer that can be used by Parties or Providers in the implementation of the system described in FIG. 1. Any device with a processing chip and network interface can be configured to be among what is now called the Internet of Things (hereafter sometimes “IOT”). FIG. 2, although not detailed, is to be considered a depiction of a logical device schematic for any mobile or stationary appliance with a processor that can be used by Parties or Providers for internet access in the implementation of the system shown and described in the specification and Figures.

FIG. 3 illustrates one possible embodiment for implementing a service based resource system and as described.

FIG. 4 illustrates a possible configuration for transferring funds electronically. There are many available electronic payment portals and platforms which could also be utilized to handle any transactions from various channels such as credit cards and debit cards to be arranged through an acquiring bank. This system may utilize front-end and/or back-end types of payment processing. Front-end processors can work through the invented system using various card associations and supply authorization and settlement services. Back-end processors can accept settlements from the invented system's frontend processors and/or via The Federal Reserve Bank for example, to move money from an issuing bank to the invented system's merchant bank connection. Payment processing is often contracted to third parties.

FIG. 5 illustrates how a judgment acquired by a Party using the system has also created an enforceable contract which can be easily converted to a state court judgment. State courts often have exclusive jurisdiction over enforcing the contract and/or instituting supplemental actions if the Party refuses to honor its commitments. Alternative dispute resolution agreements are often enforced by the courts.

### DETAILED DESCRIPTION OF THE INVENTION

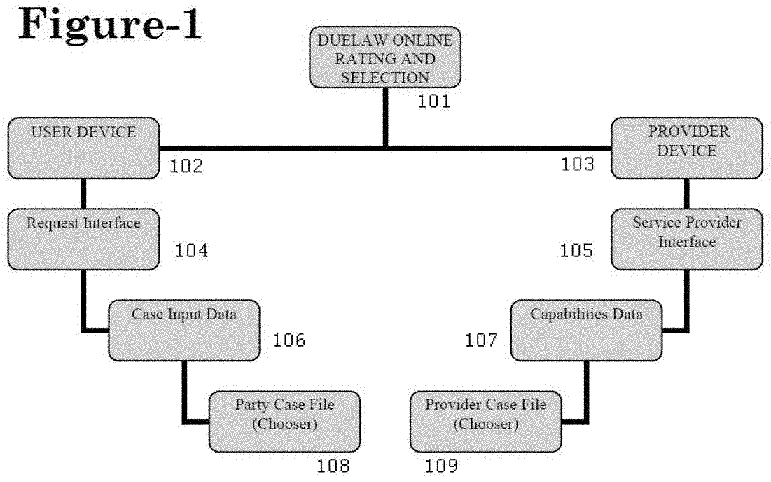

Referring to FIG. 1, a rating database (101) in several versions depending on the type of legal case or complexity and the laws of the jurisdiction, country, state, province, municipality, etc. is accessed on a series of web-enabled devices as depicted (102, 103). This system of devices and interface (104, 105) can then be used to create on demand ratings and service information for the user (Party) and service provider (Provider) entities. The system allows the users (Parties and Service Providers) to pick each other based on the cases of the Parties and the capabilities of the Providers (106, 107). The Chooser files are then used to populate the selection database from which the Party/Provider connections can be made (108, 109).

The services interface portals are accessed through stationary or mobile computing devices such as laptop, desktop, mobile smart phone, tablet, or other physical or hand-held computing device. The figure illustrates an example of where on-demand rating data for various online court entities and information metrics about Provider availability can reside. A Party user can make a request for services based on ratings, availability, qualifications, and/or other entity descriptive information or criteria made available on the rating database. The court entities can be chosen by the Party user or by the system through default assignment according to claims form generator criteria created from the Case Input Data (106). It is contemplated that judges will not be sitting judges in the same jurisdiction of any county or municipality associated to any particular case as many jurisdictional courts have rules against judges participating in the practice of law while they are sitting judges. However, just like the jurisdictional courts, in a preferred embodiment, the judges on the system contemplated must be licensed attorneys and must meet certain other qualification standards to qualify to hear a case. Likewise, attorneys must provide proof that they are licensed to practice law.

The virtual location of the forum in which the dispute is settled and the location in which the parties reside or the causes of action arose are important in determining how the disputes can be settled and in which legal jurisdiction the state and federal courts would have ultimate exclusive jurisdiction over final and binding authority. Proper jurisdiction can be determined based on the either the geographic positioning provided through the data input based on the Defendant party's place of residence or where the activities which lead to the dispute arose.

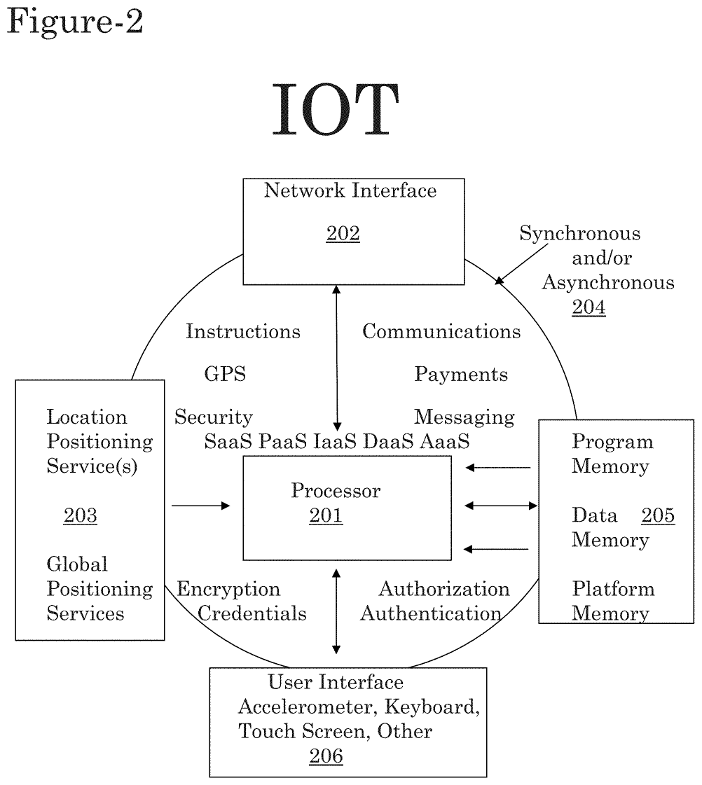

Referring to FIG. 2, mobile and/or stationary devices of any sort may obtain network access and the physical devices with internet connectivity may come in any form of IOT. Anywhere there is a processor (201) and a Network Interface (202) via screen or handset there may be a device with the connectivity illustrative of the Party and Provider logical components corresponding to one or more of a number of commercially available cellular phone, digital phone, digital pad, tablet, netbook, notebook, desktop computer, all-in-one monitor and computer, satellite phone, GPS device and screen, or other computing device (201) of today. Even your modern toaster or refrigerator can often be smarter than the best or most expensive computer of the 20th century. Illustrative of the types of services available on an IOT are: Network Interface (202); synchronous and asynchronous communications, instructions, payments, GPS, security, messaging, encryption, credentials, authorizations, and authentications (204); Software as a Service, Platform as a Service, Infrastructure as a Service, Applications as a Service, or really Anything as a Service (“XaaS”). These are not the only services available on the internet and the physical location of the programming code or memory, data memory, or platform memory (205) may reside at any given moment on any one or more user device at the same time or individually. The IOT is really an ethereal place that at any certain time may be on the network, on the processor, or even on a user interface such as a touch screen (206). The IOT here is not meant to be all inclusive or show all of the possible embodiments. Rather, the IOT is merely presented as a concept depicting the types of logical connectivity that physical hardware may embody as found in use today where a Party or Provider may engage with a device connecting to or through the invented system.

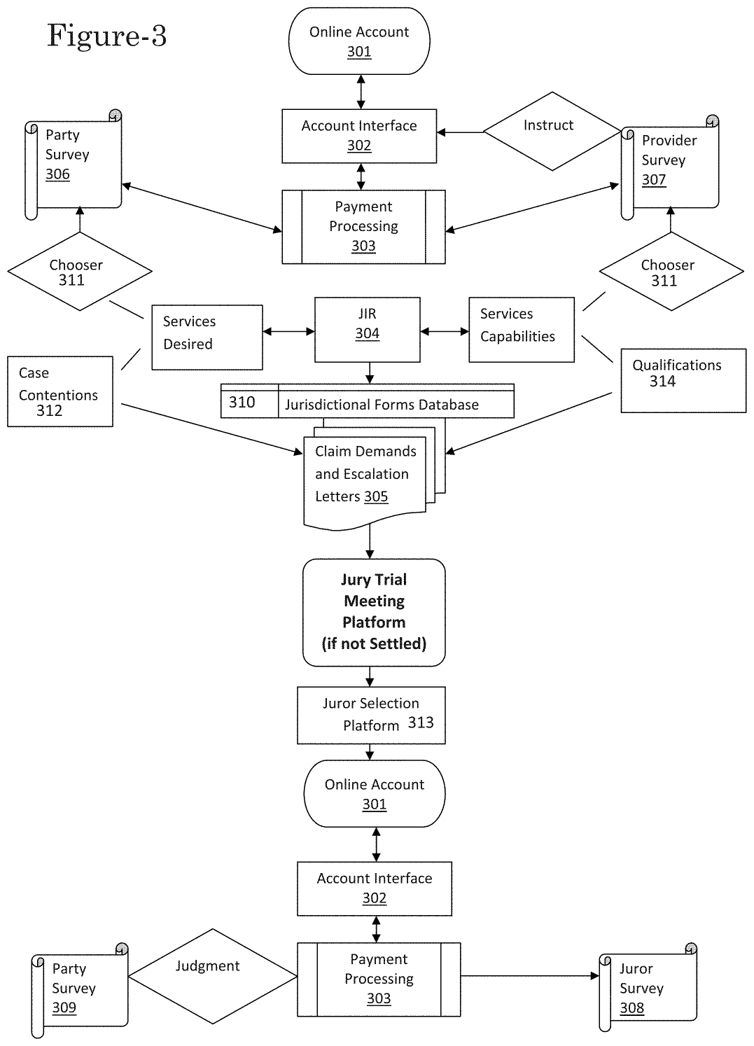

Turning to FIG. 3, a Jurisdictional Information Resource (“JIR” 304) is depicted as the central unit of the system, but many embodiments are also contemplated. The arrows, flow diagram conventions, and direction are for illustration purposes only and other electronic communication sent through any electronic channel or in any order are contemplated. A jurisdiction forms and rules repository containing all the publically available contacts, forms, fees or other documents from state, county, municipal, or other jurisdictional courts within a sovereignty such as the United States are compiled as part of the working system (310).

The volume of local forms and rules are both numerous and publically available as non-patent printed material. The local forms and rules are essential to the courts of those jurisdictions, but are not essential to the inventive step in this invention. They are there for a person of ordinary skill to use employ in making and using this invention. Any legal secretary, paralegal, attorney, or court clerk can and should understand the relevance to including the local rules and forms in this specification. The local forms and rules are therefore incorporated by reference by directing the reader to the internet for websites maintained by entities such as the “National Center for State Courts” which contains links to all 50 state court websites as well as to the websites of various bar associations throughout the country. Other websites such as wikidot legalpedia online, lexis-nexis, Thompson Reuters, Justia, digital commons, law 360, the United States Federal Courts (“dot gov”) sites, and others so numerous, to include herein are easily accessed to obtain local forms and rules. Some states are very uniform with their rules and forms, while other states have different rules for every county or municipality. These forms and rules may be obtained online for most jurisdictions or by calling or visiting courthouses in the county or municipality of jurisdiction. Prior to filing this application, the inventors have gathered rules and forms obtained through online access to the jurisdictional court systems and/or through speaking with clerks of courts across the country for specifics about how a Party would go about filing in their jurisdiction. All the forms and rules may be stored in the JIR along with the form building platforms and automated form generation using the information provided by the plaintiff Party (306) (or alternatively defendant Party if answering dispute contentions). Claim demands such as legal escalation letters (305) may be created to assist parties to settle the case, based on the proper legal jurisdiction. Rating surveys presented to the Parties and Providers (306, 307) at any stage during the advancement of the case as well as to Jurors (308) and again to the Parties after the case has been settled or decided (309) are generated and required for judgment or settlement in the preferred embodiment. Other Providers are contemplated such as judges, juries, researchers, attorneys, or other useful practitioners.

All necessary online accounts (301) may be generated with secure login credentials for the various participants which may include the Parties, the judge, the attorneys, and the jurors (if trial becomes necessary). The Account Interface (302) keeps track of participants and provides an accounting for payments and processing (303). Payment Processing may be based on settlements, judgments, ratings, or other criteria. Some cases may need to go to trial and the Juror Selection Platform (313) allows qualification and assessment of juror applicants who have been solicited via broad range multi-media and social media online channels. Jurors may be crowd sourced, but in the preferred embodiment, the jurors are asked to submit personal histories and may be subject to voir dire. A case normally begins when a plaintiff Party signs up and signs in to complete a Case Contentions form data input (312) and indicating the services desired. Party participants are encouraged to obtain attorney counsel services from the Qualifications (314) data obtained from various Provider accounts. Parties may also decline counsel and represent themselves, “pro se” in order to save money. The Chooser platform (311) allows for any participant to choose another. For example: Judges can choose cases they would desire to preside over; Parties can choose judges they would like to hear their case; Jurors can sign up for cases; and Jurors may be chosen by Attorneys and/or Parties. Other Chooser applications are contemplated and intended to be built upon as a case progresses or an area of law has been tried within the system more than one time. In addition to Party Surveys (306) all Providers and Jurors may also be asked or required to submit rating Surveys in order to get paid for their services.

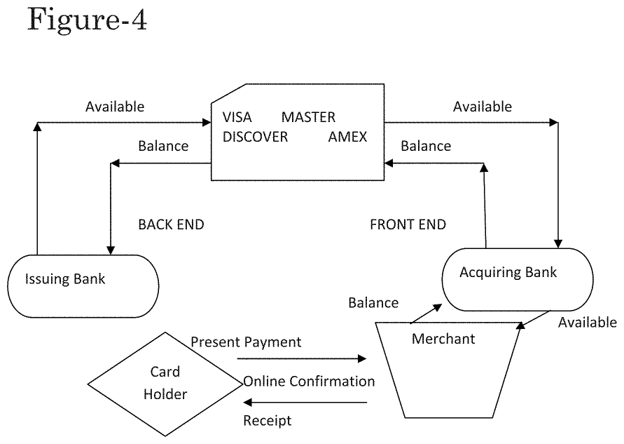

The FIG. 4 illustrations for front end and back end online payment processing are to demonstrate how to build and use payment processing platforms. Third party providers are contemplated.

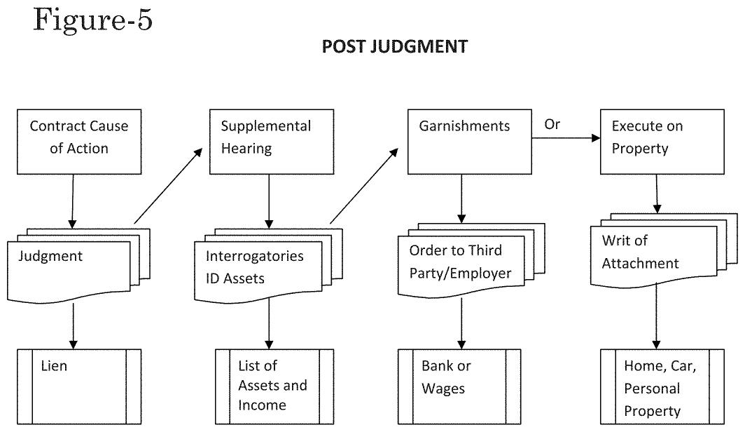

The supplemental collection proceedings illustrated in FIG. 5 may vary from jurisdiction to jurisdiction and may often need to be “localized” by obtaining a judgment in the local court. The judgment obtained by the system is contractual and enforceable, but in order to take advantage of recordable liens or garnishments, a judgment form the courts of exclusive jurisdiction may be required. Other collection methods such as credit bureau reporting and/or license suspension requests in the case of uninsured automobile accident disputes are also contemplated.

Long Felt Need

There has been a long felt need in the legal self-help services industry for a mechanism for resolving disputes in a similar way that courts do, but in an all in one online service. TV Court, which is in some respects online because it is “on-the-air” provided this type of forum, but because TV is not interactive, the number and type of participants are limited. Like TV Court, however, this invention contemplates the simultaneous use by many different litigants and legal service providers to support a way for Parties to use forum selection and choice of law by way of contract.

A system and method are described for seamlessly connecting dispute litigants with self help services, attorneys, judges, and juries through an online contract with Providers outside the typical state court systems to open new possibilities for resolving disputes. Examples described herein can be implemented using computer program modules or components which include programs, sub-routines, or software components running on or in conjunction with hardware capable of performing the disclosed tasks or functions. A program or programming module or component disclosed herein may exist on hardware independently of other programs or programming modules or components. Alternatively, a program or programming module or component can be a code generator, shared element, process of other programming modules, or may itself be another program, process, or machine. The methods described may be instructions stored in one or more memory resources of one or more computing device or programmatically performed manually by a person under direction or instruction. Some steps may not be automatic, while others may be automatic and specific modes of sending, transmitting, receiving, encrypting, encoding, decrypting or decoding, are envisioned for use with the systems and methods contemplated.

The technical infrastructure of the internet or how the information packets and/or routing of information may occur electronically is important to the making and using of this invention, however, any particular electronic communications scheme is nonessential to the functioning the invented system and methods. Any electronic or nonelectronic system of communication may fulfill the best mode so long as any of the claimed elements of the invention are understood by those who practice in the art of data communications or are familiar with internet technology, electronic commerce, or data communications in general. Several nonpatent publications under 37 C.F.R. § 1.57(e) are or may be incorporated herein by reference as the building blocks for electronic and nonelectronic communications, such as, those standards contained in the Internet protocol suite Application layer, BGP, DHCP, DNS, FTP, HTTP, IMAP, LDAP, MGCP, NNTP, NTP, POP, ONC/RPC, RTP, RTSP, RIP, SIP, SMTP, SNMP, SSH, Telnet, TLS/SSL, XMPP, and others; Transport layer protocols, such as TCP, UDP, DCCP, SCTP, RSVP, to include new and constantly developing modifications thereto; Internet layer protocols such as IP, IPv4, IPv6, ICMPICMPv6, ECN, IGMP, IPsec and more; and any number of the most current and commonly published standards for Link layers such as ARP, NDP, OSPF, Tunnels L2TP, PPP, MAC (Ethernet, DSL, ISDN, FDDI). Indeed all modes of electronic and non-electronic communication are contemplated and constantly evolving. One or more embodiments described methods, techniques, and actions herein that may be performed by a computing device or implemented as part of an overall business method which in any way can transmit or receive one or more packets of information, which may also be operative, ranging from voice, to hand gestures, to smoke signals, to plain old snail mail, telephone, telegram, or by pony express if such communications platforms are available and employed.

Some of the embodiments described herein may generally require the use of computing devices, including processing and memory resources. Some embodiments may be implemented on computing devices such as servers, desktops, mobile or cellular smart phones, laptop computers, printers, digital cameras, screens, electronic picture frames, network equipment, routers, switches, NAS drives, tablet devices, smart watches, or computing pads. User devices and network resources may be used separately or in connection with other resources including manually driven methods or implementation with any other electronic or manual system of the courts or attorney websites or application program interfaces (“APIs”). An API may be a set of routines, protocols, and tools for building software applications or may itself be a self-contained application or program. The API can specify how software components should interact and APIs are used when programming graphical user interface (GUI) components are activated by users or court entities.

In many aspects, this invention is simple. It is a condensing of the very complex legal system into a simplified and private forum. Like typical courts, state bar associations, litigation funding organizations, ADR, ODR, commercial complaint forums, or online legal form services, this invention provides a forum. But by using a continuous or constant rating system, the invention allows its users leverage to get their own unique dispute settled without a costly legal battle. All parties must agree to use the online forum. The legal leverage to resolve a dispute is the threat of a law suit in state or federal courts.

The Plaintiff/Petitioner obtains an account through online signup, and then signs in:

a. sign into system
b. Input dispute
c. filing forms for the local jurisdictional courts are prepared.
d. For a small non-refundable fee, the system generates a copyrighted demand letter with a copy of the cause of action and complaint which could be filed in the proper jurisdictional state or federal courts and mails it to the opposing party via certified mail with return receipt asking them to resolve the dispute using system.
e. If Defendant pays the claim, the case is done.
f. If the Defendant refuses to pay the claim then: the Plaintiff Party can either file the suit in the proper jurisdictional court using the forms provided and have process served on the other party or the letter may also seek agreement from the Defendant Party to resolve the claim in the forum provided by the invented system.
g. Depending on the jurisdiction, Parties may contact an attorney approved on the system for help.
h. If the other party agrees to use the system then the Parties can use online meeting tools and collaboration tools to negotiation with the system supplied forum to reach settlement
i. system online virtual meeting are allocated space (time and data resources) to mediate. (system mediators are available through low-cost approved listings)
j. Parties can get a decision through a real online bench or jury trial
k. Registered attorneys are available to any party to assess the legal theory of the case through the low cost approved engagement and Parties may utilize an attorney to represent the Party throughout the process.
l. If a Party gets a judgment or settlement in their favor and the other party does not pay, the system document database and filing guides help with collecting on the judgment through the state's supplemental proceedings with liens, levies, garnishments, or other legal collection processes for which a jurisdictional forms and rules repository containing all the publically available contacts, forms, and fees from state, county, municipal, or other jurisdictional courts within a sovereignty such as the United States are compiled as part of the working system (310).

The above described system creates a fair and affordable system which seamlessly connects dispute litigants with self-help services, attorneys, judges, and juries to open new possibilities for resolving disputes where everybody can win.

In the preferred embodiment, each party must electronically sign an engagement agreement submitting to the invented system rules and agreeing to make all decisions legally binding. Parties may submit to mediation at which time all deadlines may be suspended, for example, for up to 90 days to conduct online mediation.

If the case is not settled through mediation or if either party does not want mediation, in the preferred embodiment, the Parties have 1 week to choose judges and jurors (when demanded) and may use the ratings system in making those determinations. If the parties cannot agree on a judge, the judge will be assigned by the system based on availability and rating score. If the Party does not timely make their jury selection (3 choices) within 1 week, for example, the system will assign jurors based on availability and rating score.

Each party will have time (two weeks, for example, in the preferred embodiment) after Judge and Jury selection to submit contentions and supporting documentary evidence using the system approved online submission forms. In the preferred embodiment, no Party may submit more than a 100 page packet in supporting documents. The system may require, for example, that all documents must be submitted on standard PDF 8½×11 electronic format. The contentions normally contain all the argument. It is preferred that no argument be allowed in the supporting documents. Any argument contained in the supporting documents section may be disregarded. It is preferred that Parties are concise and accurate if they want the best chance of winning their case.

In the preferred embodiment, each party has one week after contentions to make any replies (if needed) and/or attach more supporting documents (within the 100 page limit). Judge either rules or submits instructions and verdict form to the jury within 2 weeks after final contentions.

Jury Deliberation. In a preferred embodiment, the jury has 1 week to deliberate and vote. Jury members may discuss the case on the system in a private jury forum but in best mode, may not discuss with outside 3rd parties until after the judgment is entered. Each juror gets 1 vote and in a preferred embodiment, once 4 jurors agree the verdict is submitted. A Judge can sua sponte (on his/her own) nullify any jury decision, but must demonstrate persuasively that the decision was contrary to law or against the weight of the evidence. Jurors may participate in this process, but jury nullification would normally be completed within 1 week or the verdict stands.

A party may request to nullify the jury decision but there is only one request for reconsideration that can be entered by the losing party. The Judge could be given 1 week, for example, to reverse or enter final judgment. There is normally no appeal.

In the preferred embodiment, the system utilizes all the same personnel as the legal system in any U.S. county or municipal court. Every judge and juror has the opportunity to charge for services. There is a prequalification process for any Court Entity to obtain a system account.

a. Judges. To apply to be a judge, the system could require that the they must be an attorney licensed to practice in the state where the dispute arises. In a preferred embodiment, judges are screened through a process that includes verification of good standing with the State Bar association in their states.
b. Juror. Anyone can apply to be a juror, but should be screened for conflicts or bias. A good number for jurors will be 6 jurors if demanded. Each party could be allowed to select 3 jurors.
c. Attorneys. Any attorney licensed in the forum state could apply to be eligible to assist either Plaintiffs or Defendants, but cannot also be a judge or assist the other side in any one case. Even the existence of an attorney remains confidential with the system until the end of the case, when it may be disclosed for quality, training, and rating purposes. However, any legal advice given through the system remains secure and confidential throughout the process and remains so after the case. Even the System web-team cannot access this information. The information could be accessed with permission from both the Party and the Attorney. Parties are typically not going to be prevented from receiving legal advice outside of the System.

The System has a rating system on all judges, jurors, and attorneys. And they are subject to the System fee structure which is always based on ratings. Once a case is decided, the parties may be asked to rate judges and jurors prior to any settlement disbursement (this can be required in the preferred embodiment). The System approved attorney fee structures are based in part on the number of cases tried and/or settled along with the ratings.

The System Party Entity User Accounts. The System Parties are Plaintiffs and Defendants. Just like in any court, the Plaintiff is the party that files the case. Plaintiffs have an advantage that they are the one initiating the suit and have the leverage of the legal system used to get the Defendant into court. But, once the Defendant either accepts or rejects the System created demand letters and/or agreement for services, either the state court system or the invented System may be chosen to fairly decide the case without bias. The advantage of the System is that Parties can get a judgment faster and more fairly in most circumstances than they would get in the state court system.

The System Fees and Compensation Structure. The System maintenance administrative costs of the system could be based on a percentage of the State small claims court filing fees in the preferred embodiment. The winning Party recovers the amount demanded plus costs when ruled by judge. The System fees might also be the same as the State Court small claims fees for all 50 states. If after the court forms are created, the Plaintiff wants to pursue the claim through the invented System, the Plaintiff submits the Demand fee to the System and the Demand Letter is sent to the Defendant. The Defendant may then pay the demand (upon which the case is over). Or, if the Defendant agrees to use the invented System forum, the Plaintiff then pays the remaining filing fee (receiving credit for the Demand fee already paid).

After the case is resolved (settled or decided) the amount remaining after the System administrative costs goes to the Judge (and/or Jury). A jury can be demanded by either side and the demanding party pays the jury fees. The jury fee gets divided among the jurors (Included in the System administrative costs). The fee in the preferred embodiment based on the economy at the time of filing this application could be $20 per juror or $120.

1. A forms processing system to facilitate on-demand trying or settling legal disputes, comprising:
a database storing on-demand residency information data input from
a first party in a first geographic position,
on demand residency information data input by said first party of a second party in a second geographic position, and
on-demand legal jurisdictional information data input from legal jurists or officers of the courts of last resort in multiple geographic positions;
a central processing unit (CPU) for determining forum chooser options based on the residency information data input as collated and cross-referenced to said legal jurisdiction information data input from legal jurists or offices of the courts of last resort in multiple geographic positions;
a physical input of said first party's selection based on said chooser options;
an electronic input that electronically captures said first party's selection based on said chooser options;
a data input connection to said database storing on-demand residency data and on-demand legal jurisdictional information data;
a data storage unit that stores data generated by said physical input of said first party's selection based on said choose options; and
a physical output that provides a display for transmitting or printing that includes:
printable characters on a substrate material, wherein the output is based on the subset of said first party's selection, said CPU's determination, and on said on-demand residency information data input by said first party of a second party in said second geographic position.

2. The system of claim 1 further comprising:
a data input connection to remote printer for certified delivery or verified service of process of said physical output.

3. A method for printing and processing requests for trial or settlement of legal disputes directly from remote desktop to certified U.S. postal mail third party handling comprising:
accepting as third party, the input of first party dispute information data into a database;
accepting as third party, the input of second party residency information data by said first party into said database or relational database;
accepting or inputting as third party, the input of legal jurisdictional information data based on geographical position into said database or relational database;
postulating the court of last resort presiding in a central processing unit (CPU) based on a collated and cross-referencing of said second party residency information data and legal jurisdictional information data based on geographical position;
transmitting said postulating to an electronic printer to incorporate said postulating for processing as a document;
delivering said document to a certified U.S. Postal mail depository or process server.

4. The method of claim 3 further comprising:
transmitting and demand for payment.

5. The method of claim 3 further comprising:
transmitting and offer for alternative dispute resolution.

6. The method of claim 5 further comprising;
making the offer for alternative dispute resolution contingent upon forum selection.

7. The method of claim 3 further comprising:
delivering on behalf of said first party.

8. The method of claim 3 further comprising:
providing the forum for alternative dispute resolution via remote online accessible messaging, meeting, chatting, and/or video conference.

9. The method of claim 3 further comprising:
engaging as a third party, independent fourth party interaction from one or more jurors as fact decision makers in alternative dispute resolution.

10. The method of claim 9 further comprising:
engaging as third party, independent fourth party interaction from one or more judges as fact decision makers and/or legal decision makers in alternative dispute resolution.
